(19) United States
(12) Patent Application Publication
(10) Pub. No.: US 2020/0063611 A1
(43) Pub. Date: Feb. 27, 2020

(54) METHOD OF CONTINUOUSLY VARIABLE VALVE DURATION POSITION LEARNING BASED ON RE-LEARNING SITUATION CLASSIFICATION AND CONTINUOUSLY VARIABLE VALVE DURATION SYSTEM THEREFOR

(71) Applicants: Hyundai Motor Company, Seoul (KR); Kia Motors Corporation, Seoul (KR)

(72) Inventors: Jung-Sup BYUN, Seongnam-si (KR); Hee-Nam WOO, Seoul (KR)

(73) Assignees: Hyundai Motor Company, Seoul (KR); Kia Motors Corporation, Seoul (KR)

(21) Appl. No.: 16/219,326

(22) Filed: Dec. 13, 2018

(30) Foreign Application Priority Data
Aug. 23, 2018 (KR) 10-2018-0098427

(51) Int. Cl. F01L 13/00; G06N 20/00

(52) U.S. Cl. CPC F01L 13/0015; F01L 2820/045; G06N 20/00

(57) ABSTRACT

A method of continuously variable valve duration (CVVD) location learning may include when current position information applied to valve duration control in a CVVD system is not detected by a controller, executing a re-learning mode in which re-learning of short duration and long duration is performed by classifying a situation, in which the current position information is not detected, into a plurality of non-detection situations.

### CROSS-REFERENCE TO RELATED APPLICATION

The present application claims priority to Korean Patent Application No. 10-2018-0098427, filed on Aug. 23, 2018, w the entire contents of which is incorporated herein for all purposes by this reference.

### BACKGROUND OF THE INVENTION

### Field of the Invention

The present invention relates to continuously variable valve duration (CVVD) position learning. More particularly, it relates to a CVVD system configured for optimizing learning using different learning strategies according to situations where re-learning is required.

### Description of Related Art

Generally, continuously variable valve duration (CVVD) system which is a valve variable mechanism performs learning of a valve duration (i.e., a duration of a cam operating an intake valve) at the beginning of engine assembly in an end of line (EOL) to allow an accurate duration (an open state period of the intake valve) and timing control operation. This CVVD position learning is referred to as EOL learning or initial learning.

Furthermore, various causes due to traveling of a vehicle require re-performance (i.e., re-learning) of the initial learning by requiring verification on a CVVD position learning (i.e., a valve duration position) of the CVVD system.

For example, a re-learning condition of the CVVD system may include CVVD hardware replacement (e.g., replacement of a CVVD motor and parts), a valve duration control value loss (or a current value) (e.g., a previous driving cycle stuck/learning error), CVVD hardware abnormality (a sensor failure, a motor connector detachment, or a power off, or the previous driving cycle stuck/learning error), and the like after the EOL. CVVD re-learning according to the above-described re-learning conditions acquires again a learning value which is lost due to a current position confirmation by re-learning of a short/long duration direction thereof.

Therefore, in a state in which a learning value is not acquired due to non-performance of the re-learning, the CVVD system can perform control of the short/long duration by normal control without executing a limp home mode using a default value.

However, since the re-learning brings a change of a valve position when a vehicle is accelerated (i.e., an accelerator pedal is stepped on) to cause a problem of driving ability, the CVVD re-learning is limited on an engine starting (or during the engine starting). In the instant case, the engine starting (or during the engine starting) means engine cranking subsequent to an engine key on.

Consequently, despite the variety of conditions requiring re-learning, such as CVVD motor replacement, CVVD parts replacement, a sensor failure, a motor connector detachment, a power off, a previous driving cycle stuck error, a previous driving cycle learning error, and the like, the CVVD re-learning is performed during the engine starting (i.e., an engine idle) without discriminating such conditions. As a result, in a situation of requiring re-learning, the CVVD re-learning is not optimally performed using different learning strategies according to situations.

Furthermore, the CVVD re-learning inevitably has a disadvantage in that, during an engine starting, an emergency situation requiring simultaneous short/long duration learning cannot be managed with a re-learning control strategy prioritizing engine startability and vehicle stability, which is classified into short duration learning of an engine starting and long duration learning of a vehicle acceleration.

However, since the re-learning brings a change of a valve position when a vehicle is accelerated (i.e., an accelerator pedal is stepped on) to cause a problem of driving ability, the CVVD re-learning is limited on an engine starting (or during the engine starting). In the instant case, the engine starting (or during the engine starting) means engine cranking subsequent to an engine key on.

Consequently, despite the variety of conditions requiring re-learning, such as CVVD motor replacement, CVVD parts replacement, a sensor failure, a motor connector detachment, a power off, a previous driving cycle stuck error, a previous driving cycle learning error, and the like, the CVVD re-learning is performed during the engine starting (i.e., an engine idle) without discriminating such conditions. As a result, in a situation of requiring re-learning, the CVVD re-learning is not optimally performed using different learning strategies according to situations.

Furthermore, the CVVD re-learning inevitably has a disadvantage in that, during an engine starting, an emergency situation requiring simultaneous short/long duration learning cannot be managed with a re-learning control strategy prioritizing engine startability and vehicle stability, which is classified into short duration learning of an engine starting and long duration learning of a vehicle acceleration.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method of continuously variable valve duration (CVVD) position learning based on re-learning situation classification and a CVVD system therefor, which are configured for optimizing learning by classifying re-learning situations after end portion of line (EOL) learning, and which are configured for establishing an optimal learning strategy according to each of re-learning situations with re-learning classification control which is classified into learning completion control of simultaneous short/long duration learning at the time of an engine starting, stuck removal control, and starting stability control of long duration learning at the time of a vehicle acceleration subsequent to short duration learning at the time of the engine starting.

Other objects and advantages of the present invention may be understood by the following description and become apparent with reference to the exemplary embodiments of the present invention. Also, it is obvious to those skilled in the art to which the present invention pertains that the objects and advantages of the present invention may be realized by the means as claimed and combinations thereof.

In accordance with various exemplary embodiments of the present invention, a method of continuously variable valve duration (CVVD) location learning, the method including, when current position information applied to valve duration control in a CVVD system is not detected by a controller, executing a re-learning mode in which re-learning of short duration and long duration is performed by classifying a situation, in which the current position information is not detected, into a plurality of non-detection situations.

The current position information may be detected as an existing learning value.

The re-learning mode may classify the plurality of non-detection situations into hardware replacement, a valve duration control value loss, and hardware abnormality. The hardware replacement may include replacement of a motor and parts, the valve duration control value loss may include a stuck error and a learning error during a previous driving cycle, and the hardware abnormality may include a sensor failure, a motor connector detachment, and a power off.

The re-learning mode may classify the re-learning into learning completion control in which the short duration and the long duration are simultaneously learned at a time of an engine starting in a situation of the hardware replacement, stuck removal control in which the short duration and the long duration are simultaneously learned at the time of the engine starting in a situation of the valve duration control value loss, and starting stability control in which the short duration is learned at the time of the engine starting while the long duration is learned at a time of a vehicle departure in a situation of the hardware abnormality. The engine starting may be determined by detecting engine cranking after an engine key-on.

The learning completion control may include performing, by a service tool, a forcible learning request in an engine key-on state after the hardware replacement, performing the simultaneous learning on the short duration and the long duration after the engine stating by executing a forcible learning, and storing a final learning value by setting a result of the simultaneous learning as a learning value. The result of the simultaneous learning may be stored as the final learning value when the learning value satisfies a minimum threshold value and a maximum threshold value. The result of the simultaneous learning may be stored as an error code under a condition in which the learning value does not satisfy the minimum threshold value and the maximum threshold value, and the re-learning mode is switched to a limp home mode after being interrupted.

The stuck removal control may include performing simultaneous learning in a response to a simultaneous learning request for the controller with respect to the short duration and the long duration, and switching to a valve duration control state using a simultaneous learning value, wherein the simultaneous learning value may be stored as a final learning value. The simultaneous learning result may switch a minimum threshold value and a maximum threshold value into a valve duration control state under a condition in which the learning value is satisfied. Meanwhile, the result of the simultaneous learning may be stored as an error code under a condition in which the learning value does not satisfy the minimum threshold value and the maximum threshold value, and the re-learning mode is switched to a limp home mode after being interrupted.

The starting stability control may include performing learning in a response to a learning request of the controller with respect to the short duration, sequentially performing fixing of a valve duration position and long duration learning in a response to a long duration learning request after determining a long duration learning condition, switching to a valve duration control state using a sequential learning result as a learning value, and storing the learning value as the final learning value. The method may further include determining a condition of the long duration learning by applying a vehicle speed, an engine speed, an engine torque, a gear stage, and an opening amount of an accelerator pedal, and performing the long duration learning request when a condition of a predetermined threshold value is satisfied.

A sequential learning result may switch a minimum threshold value and a maximum threshold value into a state of the valve duration control state under a condition in which the learning value is satisfied. A sequential learning result may be stored as an error code when a learning value does not satisfy a minimum threshold value and a maximum threshold value, and the re-learning mode is switched to a limp home mode.

When the current position information is detected by the controller, the controller may be switched to a valve duration control state using a conventional learning value detected through the current position information.

In accordance with various exemplary embodiments of the present invention, a continuously variable valve duration (CVVD) system may include, when current location information is not detected while valve duration control is performed with an existing learning value of detected current position information, a controller configured to perform a re-learning mode in which short duration and long duration are sequentially learned by starting stability control in a situation of hardware abnormality while simultaneously learning short duration and long duration with learning completion control in a situation of hardware replacement and stuck removal control of a valve duration control value.

The controller may perform a simultaneous learning of the learning completion control and the stuck removal control at a time of an engine starting and performs sequential learning of the starting stability control at the time of the engine starting and at a vehicle departure.

The controller may include a learning completion map, a stuck removal map, and a starting stability map, wherein the learning completion map may construct a table for motor replacement and CVVD parts replacement of the CVVD system, the stuck removal map may construct a table for a stuck error and a learning error during a previous driving cycle resulting in a CVVD valve duration learning value loss, and the starting stability map may construct a table for a motor embedded sensor failure, a motor connector detachment, and a power off.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart of a method of continuously variable valve duration (CVVD) position learning based on a re-learning situation classification according to an exemplary embodiment of the present invention.

FIG. 2 is an example of a CVVD system in which the CVVD position learning based on the re-learning situation classification according to an exemplary embodiment of the present invention is performed.

FIG. 3 is a flowchart of learning completion control in which CVVD hardware replacement is set as a re-learning condition according to an exemplary embodiment of the present invention.

FIG. 4 is a flowchart of stuck removal control in which a valve duration current value loss is set as the re-learning condition according to an exemplary embodiment of the present invention.

FIG. 5 is a flowchart of starting stability control in which CVVD hardware abnormality is set as the re-learning condition according to an exemplary embodiment of the present invention.

FIG. 6 is a graph showing an engine revolutions per minute (RPM) at the time of short direction control of the CVVD system to which a re-learning value of the CVVD position learning based on the re-learning situation classification according to an exemplary embodiment of the present invention is applied.

FIG. 7 is a graph showing an engine RPM at the time of long direction control of the CVVD system to which the re-learning value of the CVVD position learning based on the re-learning situation classification according to an exemplary embodiment of the present invention is applied.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Exemplary embodiments of the present invention will be described below in more detail with reference to the accompanying drawings, and these embodiments are examples of the present invention and may be embodied in various other different forms by those skilled in the art to which the present invention pertains so that the present invention is not limited to these embodiments.

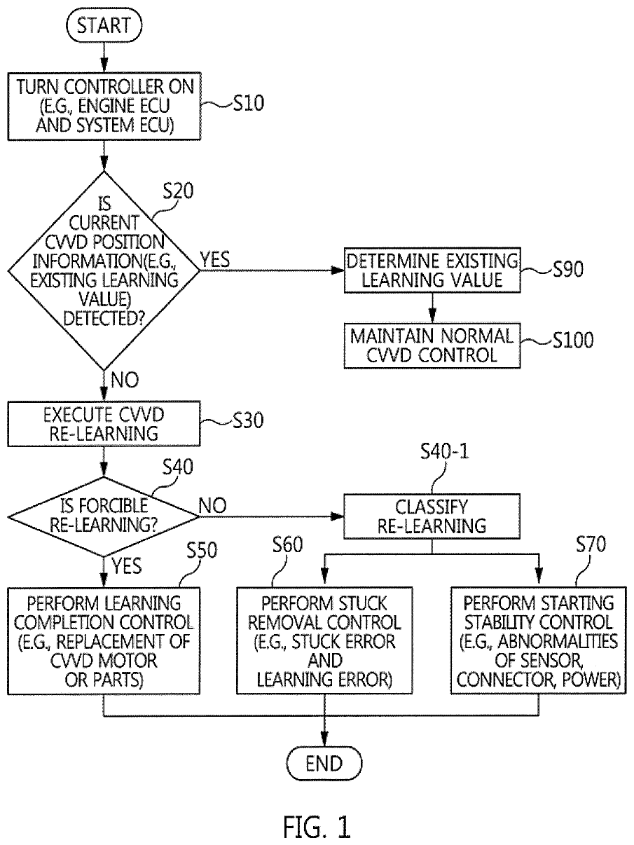

Referring to FIG. 1, a method of continuously variable valve duration (CVVD) position learning includes determining whether current CVVD position information of a CVVD system is detected by a controller (S10 and S20), executing a CVVD re-learning mode in which a learning value is newly acquired and applied according to a situation in which the current CVVD position information is not detected (S30, S40, S40-1, and S50 to S70), and executing a CVVD non-learning mode in which an existing learning value is applied according to a situation in which the current CVVD position information is detected (S90 and S100). Therefore, the method of CVVD position learning includes a method of CVVD position learning based on a re-learning situation classification.

The execution of the CVVD re-learning mode (S30, S40, S40-1, and S50 to S70) includes performing learning completion control of simultaneous short/long duration learning at the time of an engine starting (S50), performing stuck removal control (S60), and performing starting stability control in which long duration learning (at the time of a vehicle departure) is performed subsequent to short duration learning (at the time of the engine starting) (S70), and re-learning with respect to situations in which the current CVVD position information is not detected is classified according to each of the situations.

As a result, in various situations requiring re-learning, the method of CVVD position learning based on the re-learning situation classification can optimize learning with different re-learning control strategies according to the situations, and it can significantly improve the degree of freedom with respect to CVVD system control, with a re-learning control strategy, by classifying into simultaneous short/long duration learning at the time of the engine starting, short duration learning at the time of the engine starting, and long duration learning at the time of a vehicle acceleration.

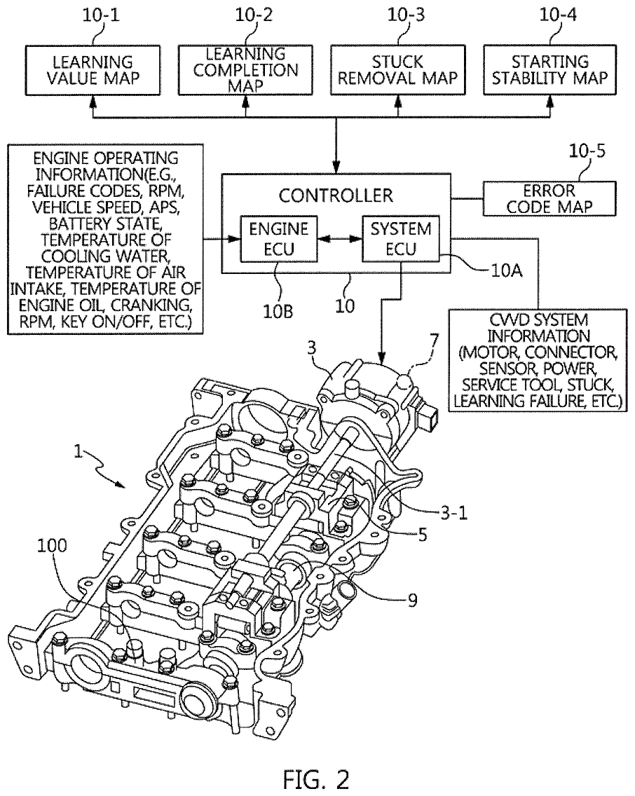

Referring to FIG. 2, a CVVD system 1 includes a motor 3, a CVVD mechanism 5, and a hall sensor 7 as components to be assembled to an engine 100, and to control the motor 3, the CVVD system 1 includes a controller 10 connected through a controller area network (CAN).

For example, the motor 3 is a brushless direct current (BLDC) three-phase motor and includes a control shaft 3-1 to allow a rotation of the motor 3 to be transmitted to a cam of a camshaft 9 under the control of the controller 10. A mechanical stopper is provided at the control shaft 3-1 to detect a rotation position of the motor 3 for short/long duration at an end portion of control shaft 3-1. The CVVD mechanism 5 is assembled to a gear engaged with the control shaft 3-1 of the motor 3, and the camshaft 9 configured to open or close intake and exhaust valves with a housing enclosing a link connected to the camshaft 9. The Hall sensor 7 is embedded in the motor 3 to convert a magnetic force into a square wave, generate a signal for each of the short/long duration according to the rotation of the motor 3 by counting the number of square waves, and provide the generated signal to the controller 10. The Hall sensor 7 is configured with a motor embedded type angular sensor having correlation with the Hall sensor 7. The angular sensor diagnoses and corrects a hall missing of the Hall sensor 7 to secure accuracy and reliability of the CVVD position learning using the Hall sensor 7 for solving the problem of Hall Missing.

For example, the controller 10 includes a system electronic control unit (ECU) 10A having the Hall sensor 7 and configured to detect a signal value for the rotation position of the motor 3, power source, a stuck error, a learning error, a service tool signal, and the like as sensor information, and an engine ECU 10B configured to detect engine operation information related to the engine 100, and the controller 10 performs CVVD control of the CVVD system 1 through mutual cooperation of the system ECU 10A and the engine ECU 10B. In the instant case, the engine operation information includes engine cranking (a rotational state of a crankshaft by a start motor), an engine RPM, an engine key ON/OFF (i.e., a state before an engine ignition), a vehicle speed, an opening amount of an accelerator pedal, a battery voltage, a temperature range of cooling water, a temperature range of intake air, and the like.

The controller 10 includes a plurality of maps 10-1, 10-2, 10-3, 10-4, and 10-5 associated with the system ECU 10A, and the maps 10-1, 10-2, 10-3, 10-4, and 10-5 may be an electrically erasable and programmable read only memory (EEPROM) and may be classified into a learning value map 10-1, a learning completion map 10-2, a stuck removal map 10-3, a starting stability map 10-4, and an error code map 10-5.

The learning value map 10-1 updates or newly stores a short/long duration learning value of the EOL, which is stored as a previous learning value, as a re-learning value while storing a default value. The learning completion map 10-2 constructs a table for CVVD motor replacement or CVVD parts replacement which is CVVD hardware replacement of which learning completion is prioritized. The stuck removal map 10-3 constructs a table for a stuck error and a learning errors of a previous driving cycle during which the CVVD system operation is prioritized and a valve duration learning value is lost. The starting stability map 10-4 constructs a table for a sensor failure, a motor connector detachment, and power off which are CVVD hardware abnormalities in which securing of startability and stability is prioritized. The error code map 10-5 generates and stores a confirm code and a permanent code for occurrence of an error in a continuous driving cycle, which are regulations requirements.

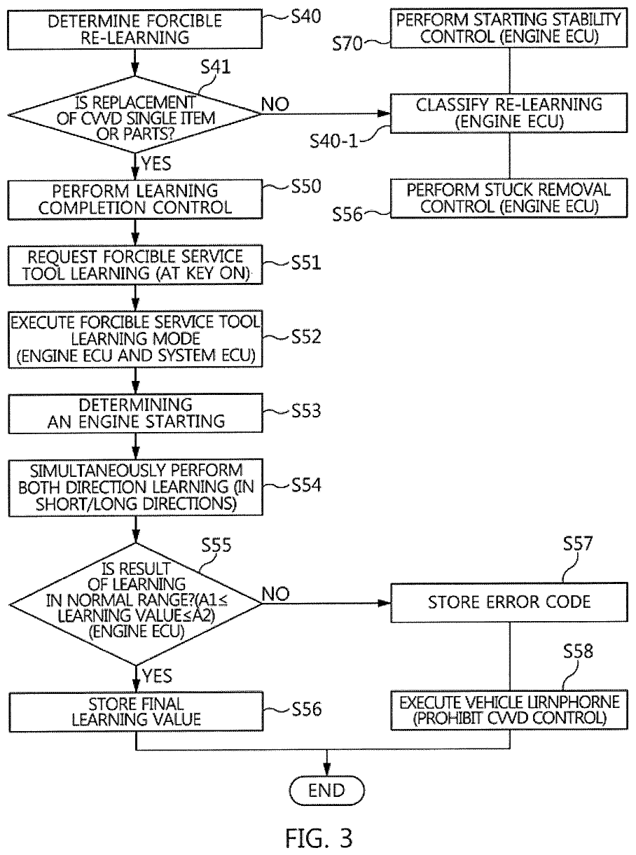

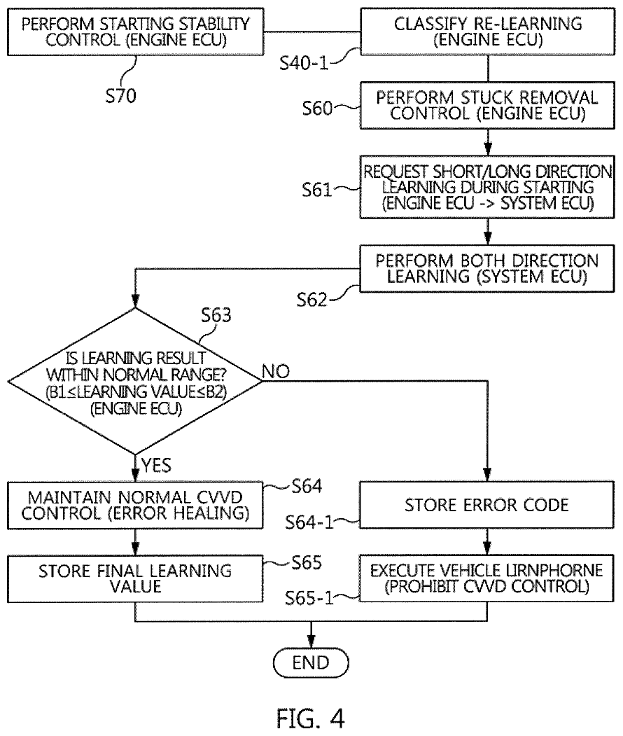

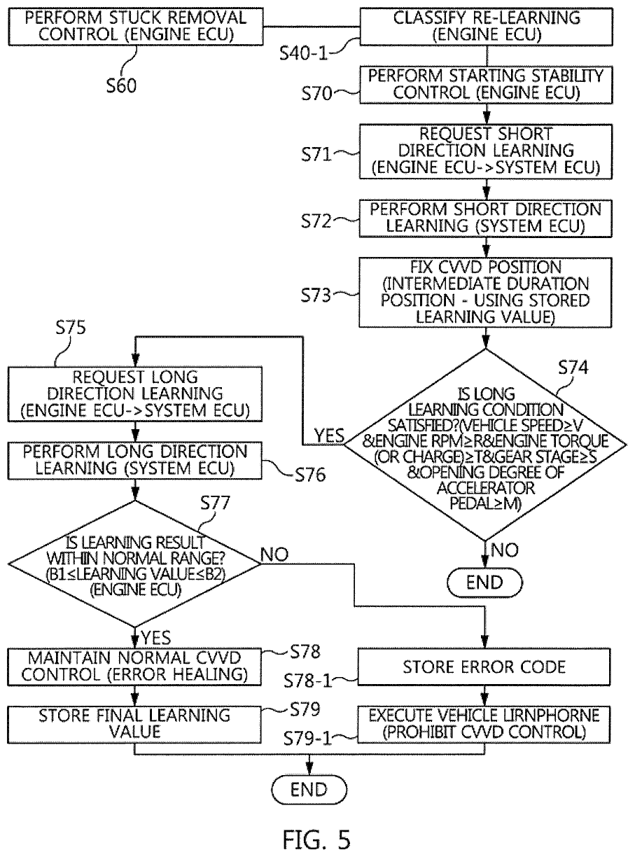

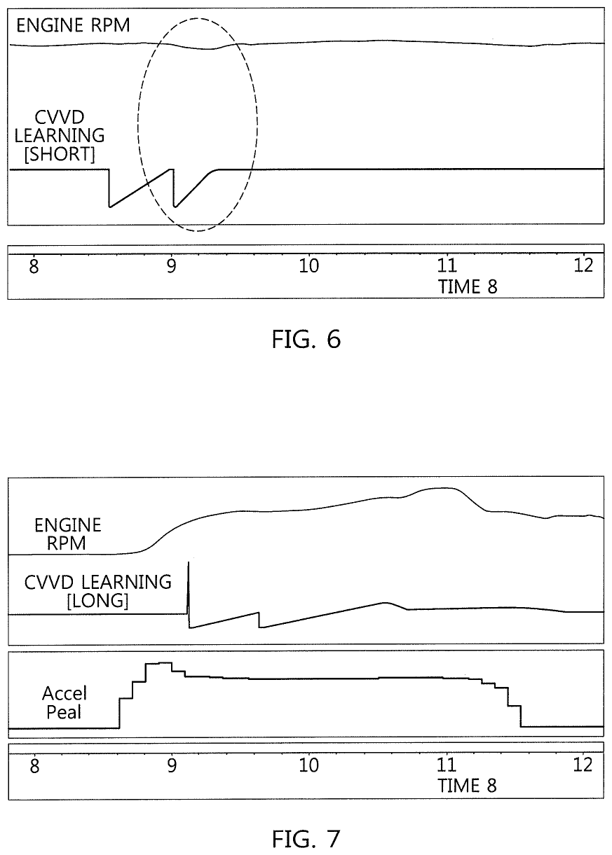

The method of CVVD position learning of FIG. 1 will be described in detail below with reference to FIG. 2, FIG. 3, FIG. 4, FIG. 5, FIG. 6, and FIG. 7. In the instant case, a control main body is the controller 10 divided into the system ECU 10A and the engine ECU 10B, control objects are the CVVD system 1 and the motor 3, and detection targets includes a signal value including the Hall sensor 7, a stuck/learning error signal, a service tool signal, and the like.

Referring to FIG. 1, the controller 10 forms a cooperative control state by performing turning a controller on in the operation S10 to activate and cooperate the system ECU 10A and the engine ECU 10B. Furthermore, in the operation S20, the controller 10 determines whether an existing learning value is present through detection of current CVVD position information. Referring to FIG. 2, the engine ECU 10B of the controller 10 recognizes starting information (i.e., a key on) to be activated to an ON state. Furthermore, the system ECU 10A of the controller 10 reads and determines the existing learning value of the short/long duration stored in the learning value map 10-1.

As a result, the controller 10 is switched to the CVVD re-learning mode (S30, S40, S40-1, and S50 to S70) in which a learning value is newly acquired and applied according to a situation in which the current CVVD position information is not detected, or to the CVVD non-learning mode (S90 and S100) in which the existing learning value is applied according to a situation in which the current CVVD position information is detected.

For example, the controller 10 performs the CVVD re-learning mode (S30, S40, S40-1, and S50 to S70) as executing CVVD re-learning (S30), determining forcible re-learning (S40), classifying re-learning (S40-1), performing learning completion control (S50), performing stuck removal control (S60), and performing starting stability control (S70).

Referring to FIG. 2, the system ECU 10A determines replacement of the motor 3 or parts as single item information (i.e., manufacturer specific information). Consequently, the determination of the forcible re-learning (S40) is performed through detection of the system ECU 10A of the controller 10 for the CVVD hardware replacement. Referring to FIG. 3, the controller 10 applies a determination result of the system ECU 10A in which replacement of the motor 3 or parts of the CVVD mechanism 5 is determined as the CVVD hardware replacement (S41).

As a result, when the system ECU 10A does not determine the replacement of the motor 3 or the parts, the controller 10 is switched to the classifying of the re-learning (S40-1). In contrast, when the system ECU 10A determined the replacement of the motor 3 or the parts, the controller 10 is switched to the performing of the learning completion control (S50).

Consequently, the performing of the learning completion control (S50) includes performing simultaneous short/long duration learning at the time of an engine starting for a re-learning situation, in which learning completion is prioritized, such as replacement of a CVVD motor or CVVD parts, and the performing of the learning completion control (S50) is concreted through FIG. 3.

The controller 10 executes the performing of the learning completion control (S50) as requesting forcible service tool learning (S51), executing the forcible service tool learning (S52), determining an engine starting (S53), performing simultaneous short/long duration learning (S54), determining a result of the simultaneous short/long duration learning (S55), storing a final learning value (S56), storing an error code (S57), and prohibiting CVVD control (S58).

Referring to FIG. 2, the controller 10 recognizes the engine key-on through the engine ECU 10B and a forcible service tool learning signal through the system ECU 10A to determine the requesting of the forcible service tool learning (S51), begin the executing of the forcible service tool learning (S52) after the engine key-on through a mutual communication between the system ECU 10A and the engine ECU 10B, perform the determining of the engine starting (S53) through detection of engine cranking by the engine ECU 10B.

As such, the controller 10 begins the performing of the simultaneous short/long duration learning (S54) by a rotation of the motor 3 caused by a control signal of the system ECU 10A. In the instant case, the performing of the simultaneous short/long duration learning (S54) means that short duration is learned in a state of the engine starting and then long duration is learned in the state of the engine starting. For example, the short duration learning is performed such that a rotation of the motor 3, which is obtained by rotating the motor 3 to a stoppage position (a position of the mechanical stopper) in a short direction with a predetermined motor duty (e.g., 50% duty) for a predetermined time (ms), is acquired as a position value, and the long duration learning is performed such that a rotation of the motor 3, which is obtained by rotating the motor 3 to a stoppage position (a position of the mechanical stopper) in a long direction with a predetermined motor duty (e.g., 50% duty) for a predetermined time (ms), is acquired as a position value.

Subsequently, the controller 10 performs the determining of the result of the simultaneous short/long duration learning (S55) with a simultaneous learning range determination formula using the engine ECU 10B.

A1≤learning value≤A2 Simultaneous Learning Range Determination Formula:

Here, “A1” is a minimum threshold value for a short duration setting value or a long duration setting value, and “A2” is a maximum threshold value for the short duration setting value or the long duration setting value. In the instant case, when a total number of rotations of the motor 3 from the short duration to the long duration is set to 1420 counts by setting 42 counts (one count=8.57) per one rotation of the motor 3, each of the minimum threshold value and the maximum threshold value is set to a value within a count range. Furthermore, the “learning value” is a short duration learning value or a long duration learning value, which is obtained through re-learning. Furthermore, “≤” is an inequality sign indicating a magnitude between two values.

Consequently, when the engine ECU 10B determines that a condition of “A1≤learning value ≤A2” is satisfied, the controller 10 performs the storing of the final learning value (S56) to store the short/long duration learning values, which are obtained through re-learning of the system ECU 10A, in the learning value map 10-1 as the final learning value. Therefore, the final learning value means an error healing for an error which is present in a previous driving cycle and, simultaneously, means that the system ECU 10A applies the final learning value to control of the motor 3. Furthermore, normal CVVD control to which the final learning value is applied means a ready state in which valve duration control is performable.

Otherwise, when the engine ECU 10B determines that the condition of “A1≤learning value ≤A2” is not satisfied, the controller 10 performs the storing of the error code (S57) to store an error code (e.g., a confirm code or a permanent code) in the error code map 10-5 through the system ECU 10A. Subsequently, the controller 10 performing the prohibiting of the CVVD control (S58) to interrupt the control of the CVVD system 1 and execute a limp home mode to which the default value is applied.

As described above, the performing of the learning completion control (S50) is characterized in that the valve duration determination and the re-learning, in which deviation of a current state according to replacement of a single CVVD item or the parts by a service center is considered, are associated with a service tool, and learning in short/long duration directions is simultaneously performed by the forcible learning performed at the time of the engine starting by a request of the service tool.

Meanwhile, in a re-learning situation to which the determining of the forcible re-learning (S40) is not applied, the controller 10 is switched to the classifying of the re-learning (S40-1), and to the present end, the controller 10 applies the stuck error or the learning error of the previous driving cycle, which is determined by the engine ECU 10B, to a loss of the valve duration control value (or a current value). This is because, although the stuck error insists to maintain a default position after the learning of the short duration direction, the default position may be varied from an expected position and idle stability of an engine may be difficult to be maintained to cause a starting off, and the learning error may eliminate a valid learning value such that determination of a default position may be impossible. As a result, when the engine ECU 10B determines the stuck error or the learning error of the previous driving cycle, the controller 10 is switched to the performing of the stuck removal control (S60).

Therefore, the performing of the stuck removal control (S60) includes performing simultaneous short/long duration learning in a re-learning situation, in which the operation of the CVVD system 1, such as the stuck error or the learning error in the previous driving cycle is prioritized, and the performing of the stuck removal control (S60) is concreted through FIG. 4.

The controller 10 executes the performing of the stuck removal control (S60) as requesting simultaneous short/long duration learning (S61), performing the simultaneous short/long duration learning (S62), determining a result of the simultaneous short/long duration learning (S63), maintaining the normal CVVD control (S64), storing a final learning value (S65), storing an error code (S64-1), and prohibiting the CVVD control (S65-1).

Referring to FIG. 2, the controller 10 determines the requesting of the simultaneous short/long duration learning (S61) in a response to a simultaneous learning request command which is transmitted to the system ECU 10A from the engine ECU 10B which recognizes the engine starting through the detection of the engine cranking subsequent to the engine key-on, and the system ECU 10A begins the performing of the simultaneous short/long duration learning (S62) during the engine starting. In the instant case, the performing of the simultaneous short/long duration learning (S62) is the same as the performing of the simultaneous short/long duration learning (S54) of the performing of the learning completion control (S50).

Subsequently, the controller 10 performs the determining of a result of determining a result of the simultaneous short/long duration learning (S63) with a simultaneous learning range determination formula using the engine ECU 10B.

B1≤learning value ≤B2 Simultaneous Learning Range Determination Formula:

Here, “B1” is a minimum threshold value for a short duration setting value or a long duration setting value, and “B2” is a maximum threshold value for the short duration setting value or the long duration setting value. In the instant case, when a total number of rotations of the motor 3 from the short duration to the long duration is set to 1420 counts by setting 42 counts (one count=8.57) per one rotation of the motor 3, each of the minimum threshold value and the maximum threshold value is set to a value within a count range. Furthermore, the “learning value” is a short duration learning value or a long duration learning value, which is obtained through re-learning. Furthermore, “≤” is an inequality sign indicating a magnitude between two values.

As a result, when the engine ECU 10B determines that a condition of “B1≤learning value ≤B2” is satisfied, the controller 10 executes the maintaining of the normal CVVD control (S64) and then performs the storing of the final learning value (S65). In the instant case, the maintaining of the normal CVVD control (S64) is a state in which the system ECU 10A controls the CVVD system 1 by applying the final learning value to the control of the motor 3. Furthermore, the storing of the final learning value (S65) is a state in which the short/long duration learning values obtained by re-learning are stored in the learning value map 10-1 through the system ECU 10A as the final learning value. Therefore, the final learning value means an error healing for an error which is present in a previous driving cycle and, simultaneously, means that the system ECU 10A applies the final learning value to control of the motor 3. Furthermore, normal CVVD control to which the final learning value is applied means a ready state in which valve duration control is performable.

Otherwise, when the engine ECU 10B determines that the condition of “B1≤learning value ≤B2” is not satisfied, the controller 10 performs the storing of the error code (S64-1) to store an error code (e.g., a confirm code or a permanent code) in the error code map 10-5 through the system ECU 10A. Subsequently, the controller 10 performing the prohibiting of the CVVD control (S65-1) to interrupt the control of the CVVD system 1 and execute a limp home mode to which the default value is applied.

As described above, the performing of the stuck removal control (S60) includes performing of the simultaneous short/long duration learning at the time of the engine starting through the re-learning on the stuck error and the learning error, which are generated in the previous driving cycle, and through the performing of the simultaneous short/long duration learning, eliminating the previous valid learning value and a stuck error problem causing difficulty in maintaining of idle stability of the engine to induce a starting off, preventing occurrence of a learning error problem, in which a default position cannot be determined, during the engine starting.

Meanwhile, in a re-learning situation to which the determining of the forcible re-learning (S40) is not applied, the controller 10 is switched to the classifying of the re-learning (S40-1), and to the present end, the controller 10 applies the stuck error or the learning error of the previous driving cycle, which is determined by the engine ECU 10B. As a result, when the stuck error or the learning error of the previous driving cycle is not determined by the engine ECU 10B, the controller 10 is switched to the performing of the starting stability control (S70)

Therefore, the performing of the starting stability control (S70) includes performing long duration learning at the time of a vehicle departure, which is subsequent to short duration learning at the time of the engine starting, by setting a re-learning situation as a situation in which securing of startability and stability of the vehicle, such as a sensor failure, a motor connector detachment, and a power off, is prioritized, and the performing of the starting stability control (S70) is concreted through FIG. 5.

The controller 10 performs the performing of the starting stability control (S70) as requesting short duration learning (S71), performing the short duration learning (S72), fixing a CVVD position (S73), determining long duration learning condition (S74), requesting long duration learning (S75), performing the long duration learning (S76), determining a sequential learning result (S77), maintaining normal CVVD control (S78), storing a final learning value (S79), storing an error code (S78-1), and prohibiting CVVD control (S79-1).

Referring to FIG. 2, the controller 10 determines the requesting of the requesting of the short duration learning (S71) in a response to a learning request command which is transmitted to the system ECU 10A from the engine ECU 10B which recognizes the engine starting through the detection of the engine cranking subsequent to the engine key-on, and the system ECU 10A begins the performing of the short duration learning (S72) during the engine starting. In the instant case, the performing of the short duration learning (S72) is performed such that a rotation of the motor 3, which is obtained by rotating the motor 3 to a stoppage position (a position of the mechanical stopper) in a short direction with a predetermined motor duty (e.g., 50% duty) for a predetermined time (ms), is acquired as a position value.

Subsequently, the controller 10 performs the fixing of the CVVD position (S73) by setting about 50% of the learning value stored in the system ECU 10A as an intermediate duration position. In the instant case, the fixing of the CVVD position (S73) includes fixing a valve duration position, and, the reason for setting 50% as the intermediate duration position is that, in state in which a previously stored learning value is valid before replacement of a CVVD single item and parts, since the performing of the short duration learning (S72) corresponds to re-learning on insufficient reliability for a current position, there is no problem for controllability even though the previous learning value is used before the performing of the long duration learning (S76).

Subsequently, the controller 10 performs the determining of the long duration learning condition (S74) with a long vehicle departure condition determination formula using the engine ECU 10B.

vehicle speed≥V& engine RPM≥R & engine torque≥T& gear stage≥S & opening amount of accelerator pedal≥M Vehicle Departure Condition Determination Formula:

Here, the “vehicle speed” is a vehicle speed detected after the engine starting, and “V” is a vehicle speed threshold value and is set to be greater than “0.” The “engine RPM” is an engine RPM detected after the engine starting, and “R” is an engine speed threshold value and is set to be greater than an RPM of idle. The “engine torque” is an engine torque detected after the engine starting, and “T” is an engine torque threshold value and is set to be greater than “0.” The “gear stage” is a gear stage detected by a gear shift operation of a driver, and “S” is a gear stage threshold value and is set to “D” or a “first stage.” The “opening amount of an accelerator pedal” is an accelerator position scope (APS) detected when the accelerator pedal is stepped on by the driver, and “M” is an APS threshold value and is set to be greater than “0.” However, each of the above-described thresholds may be set to an appropriate value according to specifications of a CVVD system and types of vehicles. Furthermore, “≥” is an inequality sign, and “&” means a “inclusion condition (and).”

As a result, when any one condition of “vehicle speed ≥V & engine RPM ≥R & engine torque ≥T & gear stage ≥S & opening amount of accelerator pedal ≥M” is determined as not being satisfied by the engine ECU 10B, the controller 10 terminates the performing of the starting stability control (S70) in the fixing of the CVVD position (S73). This means that the re-learning by the performing of the starting stability control (S70) is not completed so that a limp home mode is executed if necessary.

Otherwise, when all conditions of “vehicle speed ≥V & engine RPM ≥R & engine torque ≥T & gear stage ≥S & opening amount of accelerator pedal ≥M” are determined as being satisfied by the engine ECU 10B, the controller 10 executes the requesting of the long duration learning (S75).

As such, the controller 10 determines the requesting of the long duration learning (S75) in a response to a learning request command which is transmitted to the system ECU 10A from the engine ECU 10B which recognizes a vehicle departure subsequent to the engine starting, and the system ECU 10A begins the performing of the long duration learning (S76) at the time of the vehicle departure. In the instant case, the long duration learning is performed such that a rotation of the motor 3, which is obtained by rotating the motor 3 to a stoppage position (a position of the mechanical stopper) in a long direction with a predetermined motor duty (e.g., 50% duty) for a predetermined time (ms), is acquired as a position value.

Subsequently, the controller 10 performs the determining of the sequential learning result (S77) with a sequential learning range determination formula using the engine ECU 10B.

B1≤learning value ≤B2 Sequential learning range determination formula:

Here, “B1≤learning value ≤B2” is the same as “B1≤learning value ≤B2” which is applied to the determining of the result of the simultaneous short/long duration learning (S63), and thus a description thereof will be omitted.

Therefore, when the engine ECU 10B determines whether the condition of “B1≤learning value ≤B2” is satisfied, the controller 10 performs the maintaining of the normal CVVD control (S78) and the storing of the final learning value (S79). In the instant case, the maintaining of the normal CVVD control (S78) is performed in a state in which the system ECU 10A controls the CVVD system 1 by applying the final learning value to the control of the motor 3, and the storing of the final learning value (S79) is performed in a state in which error healing is performed by storing the short/long duration learning values, which are obtained by the re-learning through the learning value map 10A, in the learning value map 10-1 as the final learning value. Furthermore, the normal CVVD control to which the final learning value is applied means a ready state in which valve duration control is performable.

Furthermore, when the condition of “B1≤learning value ≤B2” is determines as not being satisfied by the engine ECU 10B, the controller 10 performs the storing of the error code (S78-1) and the prohibiting of the CVVD control (S79-1). In the instant case, it means that the storing of the error code (S78-1) is performed to store an error code (e.g., a confirm code or a permanent code) in the error code map 10-5 through the system ECU 10A, and the storing of the error code (S78-1) is performed in the limp home mode.

As described above, the performing of the starting stability control (S70) is executed such that the sequential re-learning, in which the short duration learning of the engine starting and the long duration learning of the vehicle departure are discriminated with respect to the sensor failure, the motor connector detachment, or the power off, is performed and, consequently, startability and the stability of the vehicle are secured without problems of engine RPM stability and starting off, which may occur due to the long duration learning at the time of the engine starting.

Meanwhile, FIG. 6 and FIG. 7 illustrate a CVVD control test state of the CVVD system 1 to which the final learning value acquired in each of the operations S56, S65, and S79 through the method of CVVD position learning based on a re-learning situation classification is applied. For example, in FIG. 6, the engine RPM is substantially constant without an RPM drop according to the short direction control so that it is experimentally proved that there is no problem in engine idle stability and engine startability. For example, in FIG. 7, the engine RPM is continuously increased according to depression of the accelerator pedal without an RPM down so that it is experimentally proved that there is no problem in driving ability of the vehicle at the time of vehicle acceleration.

Referring back to FIG. 1, the controller 10 performs the executing of the CVVD non-learning mode (S90 and S100) as determining the existing learning value (S90) and maintaining the normal CVVD control (S100). Therefore, it means that the determining of the existing learning value (S90) is performed to read values stored in the learning value map 10-1 through short/long duration learning of the EOL, and the maintaining of the normal CVVD control (S100) is performed in a state in which the system ECU 10A controls the CVVD system 1 by applying the existing learning value to the control of the motor 3. Furthermore, the normal CVVD control to which the existing learning value is applied means a ready state in which valve duration control is performable.

As described above, the method of CVVD position learning based on a re-learning situation classification, which is applied to the CVVD system 1, according to the exemplary embodiment of the present invention is performed such that, when current location information cannot be detected while the controller performs valve duration control of the CVVD system 1 with an existing learning value of detected current position information, short duration and long duration may be simultaneously learned at the time of an engine starting with learning completion control in a hardware replacement state and stuck removal control in which a valve duration control value is lost, whereas a re-learning mode in which short duration is learned at the time of the engine starting and then long duration is learned at the time of a vehicle departure is performed with starting stability control in a state of hardware abnormality such that a re-learning optimization strategy according to each of situations after an EOL learning may be established.

The method of CVVD position learning applied to the CVVD system of the present invention realizes re-learning classification control based on a re-learning situation classification, implementing the following actions and effects.

First, even when re-learning is required due to various causes, the CVVD system may be prevented from executing a limp home mode due to non-performance of the re-learning such that normal valve duration control may be always maintained. Second, a re-learning classification control logic according to each of re-learning situations is applied such that appropriate re-learning suitable for each of the re-learning situations may be performed to secure effects of avoiding problem situations in which the CVVD system may execute, and engine startability. Third, error or normal determination for the CVVD system is performed without any problem such that regulations requirements of the CVVD system (e.g., storing of a confirmation code and a permanent code with respect to an error occurrence during continuous driving cycles) may be easily satisfied. Fourth, simultaneous short/long duration learning is performed at the time of the engine starting such that re-learning focusing on operability of parts may be performed by prioritizing learning completion control rather than engine startability, or shortening stuck removal control rather than a learning purpose. Fifth, re-learning focusing on engine startability and vehicle stability may be performed with starting stability control through short duration learning at the time of the engine starting and, subsequently, long duration learning at the time of vehicle acceleration.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of continuously variable valve duration (CVVD) location learning, comprising:
when current position information applied to valve duration control in a CVVD system is not detected by a controller, executing a re-learning mode in which re-learning of short duration and long duration is performed by classifying a situation, in which the current position information is not detected, into a plurality of non-detection situations.

2. The method of claim 1, wherein the current position information is detected as an existing learning value.

3. The method of claim 1, wherein the re-learning mode is configured to classify the plurality of non-detection situations into hardware replacement, a valve duration control value loss, and hardware abnormality.

4. The method of claim 3,
wherein the hardware replacement includes replacement of a motor and parts;
wherein the valve duration control value loss includes a stuck error and a learning error during a previous driving cycle; and
wherein the hardware abnormality includes a sensor failure, a motor connector detachment, and a power off.

5. The method of claim 3,
wherein the re-learning mode is configured to classify the re-learning into learning completion control in which the short duration and the long duration are simultaneously learned at a time of an engine starting in a situation of the hardware replacement, stuck removal control in which the short duration and the long duration are simultaneously learned at a time of the engine starting in a situation of the valve duration control value loss, and starting stability control in which the short duration is learned at a time of the engine starting while the long duration is learned at a time of a vehicle departure in a situation of the hardware abnormality.

6. The method of claim 5, wherein the engine starting is determined by detecting engine cranking after an engine key-on.

7. The method of claim 5,
wherein the learning completion control includes:
performing, by a service tool, a forcible learning request in an engine key-on state after the hardware replacement;
performing the simultaneous learning on the short duration and the long duration after the engine stating by executing a forcible learning; and
storing a final learning value by setting a result of the simultaneous learning as a learning value.

8. The method of claim 7,
wherein the result of the simultaneous learning is stored as the final learning value when the learning value satisfies a minimum threshold value and a maximum threshold value.

9. The method of claim 7,
wherein the result of the simultaneous learning is stored as an error code when the learning value does not satisfy a minimum threshold value and a maximum threshold value, and the re-learning mode is switched to a limp home mode after being interrupted.

10. The method of claim 5,
wherein the stuck removal control includes:
performing simultaneous learning in a response to a simultaneous learning request for the controller with respect to the short duration and the long duration; and
switching to a valve duration control state using a simultaneous learning value,
wherein the simultaneous learning value is stored as a final learning value.

11. The method of claim 10,
wherein the simultaneous learning result is configured to switch a minimum threshold value and a maximum threshold value into a valve duration control state when a learning value is satisfied.

12. The method of claim 10,
wherein the result of the simultaneous learning is stored as an error code when the learning value does not satisfy a minimum threshold value and a maximum threshold value, and the re-learning mode is switched to a limp home mode after being interrupted.

13. The method of claim 5, wherein the starting stability control includes:
performing learning in a response to a learning request of the controller with respect to the short duration;
sequentially performing fixing of a valve duration position and a long duration learning in a response to a long duration learning request after determining a long duration learning condition;
switching to a valve duration control state using a sequential learning result as a learning value; and
storing the learning value as the final learning value.

14. The method of claim 13, further including:
determining a condition of the long duration learning by applying a vehicle speed, an engine speed, an engine torque, a gear stage, and an opening amount of an accelerator pedal; and
performing the long duration learning request when a condition of a predetermined threshold value is satisfied.

15. The method of claim 13, wherein a sequential learning result switches a minimum threshold value and a maximum threshold value into a state of the valve duration control state when the learning value is satisfied.

16. The method of claim 13, wherein a sequential learning result is stored as an error code when a learning value does not satisfy a minimum threshold value and a maximum threshold value, and the re-learning mode is switched to a limp home mode.

17. The method of claim 1, wherein, when the current position information is detected by the controller, the controller is switched to a valve duration control state using an existing learning value detected through the current position information.

18. A continuously variable valve duration (CVVD) system, comprising:
a controller configured to perform a re-learning mode in which short duration and long duration are sequentially learned by starting stability control in a situation of hardware abnormality while simultaneously learning the short duration and the long duration with learning completion control in a situation of hardware replacement and stuck removal control of a valve duration control value, when current location information is not detected while valve duration control is performed with an existing learning value of detected current position information.

19. The CVVD system of claim 18, wherein the controller is configured to perform a simultaneous learning of the learning completion control and the stuck removal control at a time of an engine starting and is configured to perform sequential learning of the starting stability control at a time of the engine starting and at a vehicle departure.

20. The CVVD system of claim 18,
wherein the controller includes a learning completion map, a stuck removal map, and a starting stability map,
wherein the learning completion map constructs a table for motor replacement and CVVD parts replacement of the CVVD system;
wherein the stuck removal map constructs a table for a stuck error and a learning error during a previous driving cycle resulting in a CVVD valve duration learning value loss; and
wherein the starting stability map constructs a table for a motor embedded sensor failure, a motor connector detachment, and a power off.
